(19) United States
(12) Patent Application Publication
(10) Pub. No.: US 2025/0355298 A1
(43) Pub. Date: Nov. 20, 2025

(54) DISPLAY APPARATUS

(71) Applicant: SAMSUNG ELECTRONICS CO., LTD., Suwon-si (KR)

(72) Inventors: Sungpil CHOI, Suwon-si (KR); Dukjin Jeon, Suwon-si (KR); Yeonkyun Park, Suwon-si (KR); Yonghwan Park, Suwon-si (KR)

(73) Assignee: SAMSUNG ELECTRONICS CO., LTD., Suwon-si (KR)

(21) Appl. No.: 19/282,310

(22) Filed: Jul. 28, 2025

Related U.S. Application Data
(63) Continuation of application No. PCT/KR2023/021125, filed on Dec. 20, 2023.

(30) Foreign Application Priority Data
Feb. 24, 2023 (KR) 10-2023-0025403

(51) Int. Cl. G02F 1/13357; F21V 8/00; G02F 1/1335

(52) U.S. Cl. CPC G02F 1/133615; G02B 6/0073; G02F 1/133628

(57) ABSTRACT

A display apparatus includes a liquid crystal panel configured to display an image in a first direction at a first side of liquid crystal panel; a light guide plate on a second side of the liquid crystal panel opposite to the first side of the liquid crystal panel; a light source module facing a thickness side surface of the light guide plate to and configured emit light toward the thickness side surface of the light guide plate, the light source module including a plurality of light sources arranged along a second direction orthogonal to the first direction, wherein each light source of the plurality of light sources includes: a light-emitting diode attached to a printed circuit board, and an optical dome completely covering the light-emitting diode.

### CROSS-REFERENCE TO RELATED APPLICATIONS

This application is continuation of International Application No. PCT/KR2023/021125 filed on Dec. 20, 2023, which is based on and claims priority to Korean Patent Application No. 10-2023-0025403, filed on Feb. 24, 2023, in the Korean Intellectual Property Office, the disclosures of which are incorporated by reference herein in their entireties.

### BACKGROUND

### 1. Field

The disclosure relates to a display apparatus including an edge-type backlight unit.

### 2. Description of Related Art

In general, a display apparatus converts acquired or stored electrical information into visual information and displays such information to a user, and is used in various fields such as homes and businesses.

A display apparatus may include a liquid crystal panel and a backlight unit that supplies light to the liquid crystal panel.

The backlight unit includes a light source module including a light source and a printed circuit board, and various optical members, and may be categorized into a direct-type and an edge-type depending on the position of the light source. The edge-type backlight unit further includes a light guide plate (LGP) to guide light emitted from the light source to the liquid crystal panel.

Since a light-emitting diode (LED), which is a light source, has a narrow light emission angle due to the characteristics of a point light source, a more than necessary number of LEDs should be arranged on the printed circuit board to prevent the occurrence of hot spots, where bright and dark areas appear.

### SUMMARY

Provided is a display apparatus including an edge-type backlight unit with an optical dome configured to diffuse light.

Further, provided is a display apparatus having an edge-type backlight unit that may be capable of reducing hot spots while reducing the number of light sources.

Further, provided is a display apparatus that has high energy efficiency and may secure thermal stability.

Additional aspects will be set forth in part in the description which follows and, in part, will be apparent from the description, or may be learned by practice of the presented embodiments.

According to an aspect of the disclosure, a display apparatus includes: a liquid crystal panel configured to display an image in a first direction at a first side of liquid crystal panel; a light guide plate on a second side of the liquid crystal panel opposite to the first side of the liquid crystal panel; a light source module facing a thickness side surface of the light guide plate to and configured emit light toward the thickness side surface of the light guide plate, the light source module including a plurality of light sources arranged along a second direction orthogonal to the first direction, wherein each light source of the plurality of light sources includes: a light-emitting diode attached to a printed circuit board, and an optical dome completely covering the light-emitting diode.

The light-emitting diode may be attached to the printed circuit board by a chip on board process.

The optical dome may include: a first surface in contact with a surface of the printed circuit board; and a second surface opposite to the first surface and forming a light emission surface.

The second surface may have a spherical shape.

The second surface may have an aspherical shape.

The second surface may include a curved portion and a straight portion.

The curved portion may be on an upper portion of the light-emitting diode, and the straight portion may be on a side of the light-emitting diode.

The straight portion is on an upper portion of the light-emitting diode, and the curved portion is on a side of the light-emitting diode.

The second surface may include at least one convex portion and at least one concave portion.

The at least one concave portion may be provided around a central axis of the optical dome.

The at least one convex portion may have a symmetrical structure with respect to a central axis of the optical dome.

The second surface may include a plurality of protrusions.

The second surface may include a light-transmitting sheet on which a plurality of protrusions are provided.

The plurality of protrusions may be on a side of the optical dome.

The optical dome may include silicone.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating an exterior of a display apparatus according to an embodiment of the present disclosure;

FIG. 2 is an exploded view illustrating a configuration of the display apparatus according to an embodiment of the present disclosure;

FIG. 3 is a cross-sectional view of the display apparatus according to an embodiment of the present disclosure;

FIG. 4 is a view illustrating a light guide plate and a light source module according to an embodiment of the present disclosure;

FIG. 5 is a perspective view of a light source according to an embodiment of the present disclosure;

FIG. 6 is an exploded perspective view of the light source according to an embodiment of the present disclosure;

FIG. 7 is a cross-sectional view taken along line A-A′ shown in FIG. 5;

FIG. 8 is a view illustrating a light emission angle of a light source module according to an embodiment of the present disclosure;

FIG. 9 is a view illustrating a light emission angle of a related art LED package;

FIG. 10 is a view illustrating an optical dome and a light guide plate according to an embodiment of the present disclosure;

FIGS. 11 to 17 are views illustrating an optical dome according to an embodiment of the present disclosure.

### DETAILED DESCRIPTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

Also, the terms used herein are used to describe the embodiments and are not intended to limit and/or restrict the disclosure. The singular forms “a”, “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In addition, in the present disclosure, the meaning of “identical” includes cases where properties are similar to each other or similar within a certain range. Furthermore, identical means “substantially identical”. The meaning of substantially identical should be understood to include numerical values within manufacturing error ranges or differences within a range that is insignificant with respect to a reference numerical value as falling within the scope of ‘identical’.

In addition, terms such as “part”, “portion”, “unit”, “block”, “member”, “module”, and the like, may refer to a unit that processes at least one function or operation. For example, these terms may refer to at least one hardware such as a field-programmable gate array (FPGA)/application specific integrated circuit (ASIC), at least one software stored in memory, or at least one process processed by a processor.

Terms used in the following description such as “front”, “rear”, “left”, and “right”, and the like, are defined based on the drawings, and the shape and position of each element are not limited by these terms.

Hereinafter, various embodiments of the disclosure will be described in detail with reference to the accompanying drawings.

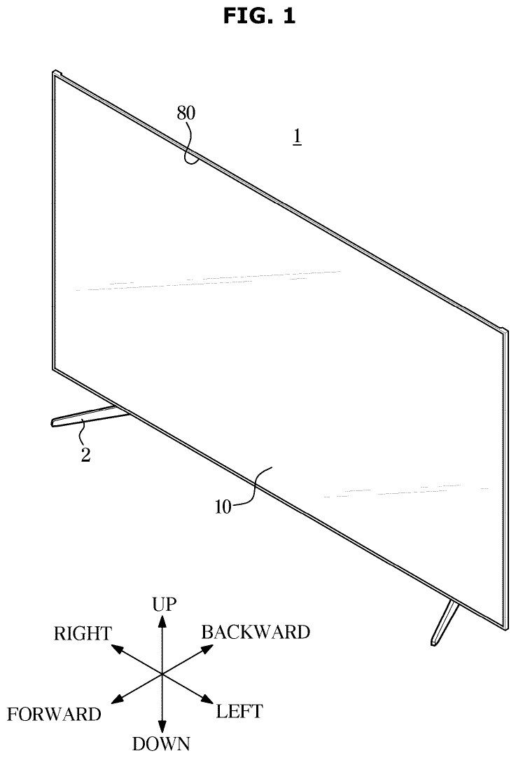

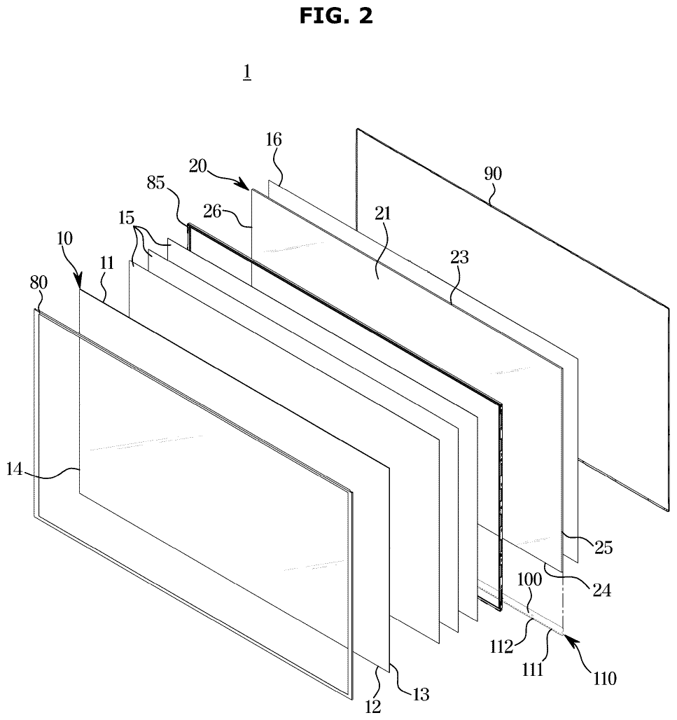

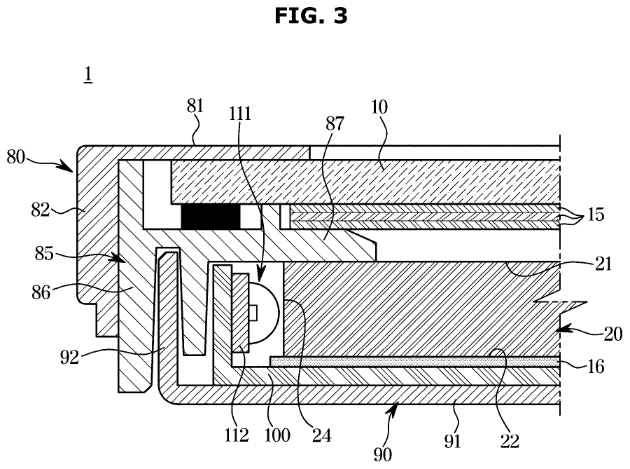

FIG. 1 is a view illustrating an exterior of a display apparatus according to an embodiment of the present disclosure. FIG. 2 is an exploded view illustrating a configuration of the display apparatus according to an embodiment of the present disclosure. FIG. 3 is a cross-sectional view of the display apparatus according to an embodiment of the present disclosure.

Referring to FIGS. 1 to 3, a display apparatus 1 may be an apparatus that displays information, materials, data, and the like, in the form of characters, shapes, graphs, images, and the like, and may include a television (TV), which is a long-distance communication medium for transmitting video and image signals, and a monitor, which is a type of computer output device. The display apparatus 1 may be a flat display device with a flat screen as in the present embodiment, or unlike the present embodiment, a curved display device with a curved screen, or a bendable display device in which a screen thereof may be varies from flat to curved and from curved to flat, or in which the curvature of a curved surface varies.

Furthermore, the display apparatus 1 may be applied to all display devices regardless of screen size. For example, it may be applied to products that may be installed on tables, walls, ceilings, or the like, such as smart televisions and monitors, as well as portable products, such as tablets, laptops, smartphones, e-books, or the like.

The display apparatus 1 may be installed in a standing manner on an indoor or outdoor floor or furniture, or may be installed in a wall-mounted manner on a wall or inside a wall. The display apparatus 1 may be provided with support legs 2 on a lower portion thereof to be installed in a standing manner on a floor or furniture indoors or outdoors.

The display apparatus 1 may include a liquid crystal panel 10 that displays an image, a backlight unit that illuminates the liquid crystal panel 10 with light, and a chassis assembly that supports the liquid crystal panel 10 and the backlight unit.

The liquid crystal panel 10 may display an image using liquid crystals that exhibit optical properties in response to changes in voltage and temperature. The liquid crystal panel 10 may comprise a thin film transistor (TFT) substrate and a color filter (CF) substrate coupled to the TFT substrate to face each other, and liquid crystals injected between the TFT substrate and the CF substrate.

A screen of the liquid crystal panel 10 may be an approximately rectangular shape. The screen of the liquid crystal panel 10 may have a pair of long sides 11 and 12 and a pair of short sides 13 and 14. The liquid crystal panel 10 may display the screen toward a front, which is a first direction (i.e., a forward).

The backlight unit may include a light source module 110 including a plurality of light sources 111 that emit light, and a light guide plate 20 that guides light emitted from the plurality of light sources 111 to the liquid crystal panel 10.

The light source module 110 may further include a printed circuit board 112 on which the plurality of light sources 111 are mounted. The printed circuit board 112 may include circuit patterns, and the like for delivering drive power and signals to the light sources 111.

The plurality of light sources 111 may be arranged in a line on the printed circuit board 112. The plurality of light sources 111 may be mounted on the printed circuit board 112 so as to be spaced apart from each other at regular intervals.

The light guide plate 20 may be located on a rear side of the liquid crystal panel 10. The light guide plate 20 may convert light emitted from the light source 111 into surface light and guide the converted light to the liquid crystal panel 10. The light guide plate 20 may be formed of a poly methyl methacrylate acrylate (PMMA) material. Various patterns may be formed on the light guide plate 20 to vary the path of light.

The light guide plate 20 may be formed in an approximately cuboidal shape. In other words, the light guide plate 20 may have a front surface 21, a rear surface 22, and thickness surfaces 23, 24, 25 and 26. The thickness surfaces 23, 24, 25 and 26 may include an upper thickness surface 23, a lower thickness surface 24, a left thickness surface 25, and a right thickness surface 26. Light may be incident on the light guide plate 20 through at least one of the thickness surfaces 23, 24, 25 and 26 of the light guide plate 20, and light may be emitted from the light guide plate 20 through the front surface 21 of the light guide plate 20. The light emitted through the front surface 21 of the light guide plate 20 may be guided to the liquid crystal panel 10. Accordingly, a surface of the light guide plate 20 on which light is incident among the thickness surfaces 23, 24, 25 and 26 of the light guide plate 20 may be referred to as an incident surface of the light guide plate 20, and the front surface 21 of the light guide plate 20 may be referred to as an emission surface of the light guide plate 20.

In an example, the light source 111 may emit light toward the lower thickness surface 24 of the thickness surfaces 23, 24, 25 and 26 of the light guide plate 20. To this end, the light source 111 may be disposed facing the lower thickness surface 24 of the light guide plate 20. The printed circuit board 112 may be disposed elongate in a second direction, which is a left-to-right direction, so as to be parallel to the lower thickness surface 24 of the light guide plate 20. The plurality of light sources 111 may be arranged at predetermined intervals in the left-to-right direction so as to be parallel to the lower thickness surface 24.

In an example, the light sources 111 may be disposed adjacent to at least one of the thickness surfaces 23, 24, 25 and 26 of the light guide plate 20 such that light is incident on the light guide plate 20 through at least one of the thickness surfaces 23, 24, 25 and 26.

When a gap between the light source 111 and the light guide plate 20 varies, the luminance of the display apparatus may vary. Accordingly, a distance between the light source 111 and the light guide plate 20 should be kept constant to allow the luminance of the display apparatus to remain constant.

The backlight unit may include a reflective sheet 16 to reflect light to prevent light loss, and various optical sheets 15 to improve optical properties.

The reflective sheet 16 may be disposed on a rear surface of the light guide plate 20 to cause light emitted from the light source 111 to be incident on the light guide plate 20, or to cause light emitted from the light guide plate 20 to be incident back on the light guide plate 20.

The optical sheet 15 may include a quantum dot sheet that improves color reproducibility by changing a wavelength of light. The quantum dot sheet may have a dispersed arrangement of quantum dots, which are semiconductor crystals of several nanometers in size that emit light, therein. Quantum dots may receive blue light and, depending on their size, may generate light of various wavelengths, i.e., all colors of visible light. The optical sheet 15 may include a diffusion sheet to offset an effect caused by the pattern of the light guide plate 20. The optical sheet 15 may include a prism sheet to concentrate light to improve luminance.

The display apparatus 1 may include a chassis assembly that accommodates and supports the liquid crystal panel 10 and the backlight unit. The chassis assembly may include a front chassis 80, a middle mold 85, and a rear chassis 90.

The front chassis 80 may be provided in a rectangular frame shape on a front surface of the display apparatus 1. The front chassis 80 may include a bezel portion 81 forming a bezel, and a rear extension portion 82 extending rearwardly from the bezel portion 81.

The middle mold 85 may be coupled to a rear side of the front chassis 80. The middle mold 85 may include a side portion 86 provided in a rectangular frame shape, and an intermediate support portion 87 protruding from the side portion 86 to support the light guide plate 20 and the optical sheet 15.

The rear chassis 90 may have a substantially plate shape and may be coupled to a rear side of the middle mold 85. The rear chassis 90 may be made of a metal material, such as aluminum, stainless steel (SUS), or the like, with good thermal conductivity, or a plastic material, such as ABS, to dissipate heat generated by the light source 111 to an outside. The rear chassis 90 may include a base 91 located on a rear side of the light guide plate 20, and a front extension portion 92 extending forwardly from an edge of the base 91.

A rear cover forming a rear exterior of the display apparatus 1 may be coupled to a rear side of the rear chassis 90. The support legs 2 described above may be coupled to the rear cover.

However, in contrast to the present embodiment, any one of the front chassis 80, the middle mold 85, and the rear chassis 90 may be omitted.

The display apparatus 1 may include a heat dissipation member (e.g., a heat sink) 100 for dissipating heat generated by the plurality of light sources 111 of the light source module 110.

The heat dissipation member 100 may be provided to be coupled to the rear chassis 90. The heat dissipation member 100 may be configured to receive heat generated by the light source module 110 and to dissipate heat from the light source module 110.

In an example, a thermal expansion coefficient of a material constituting the heat dissipation member 100 may be provided to be greater than a thermal expansion coefficient constituting the rear chassis 90.

In an example, a thermal conductivity of a material constituting the heat dissipation member 100 may be provided to be greater than a thermal conductivity constituting the rear chassis 90.

In an example, the heat dissipation member 100 may be made of an aluminum material. In an example, the rear chassis 90 may be made of a steel material, such as a steel plate.

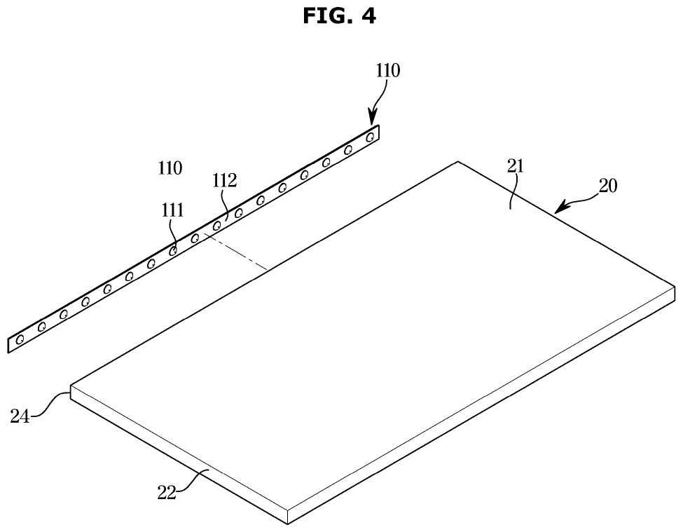

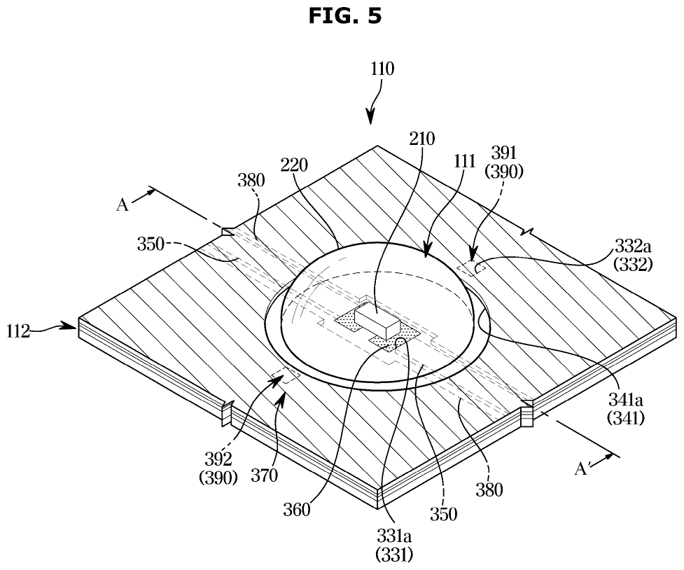

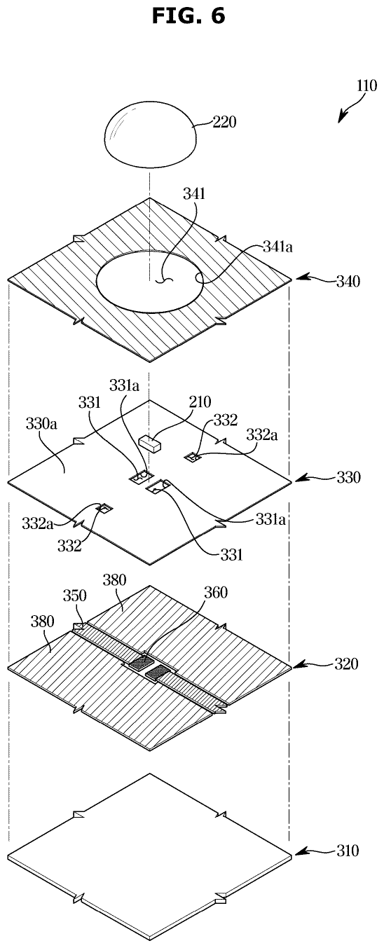

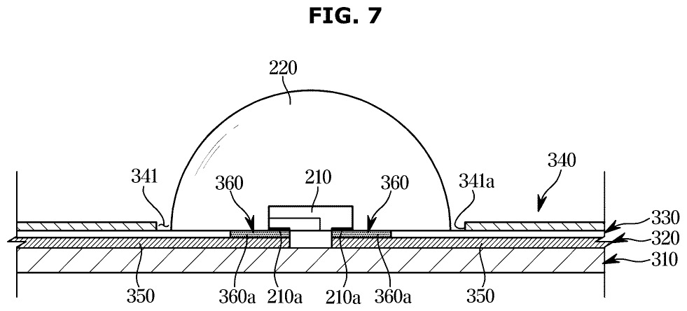

FIG. 4 is a view illustrating the light guide plate and the light source module according to an embodiment of the present disclosure. FIG. 5 is a perspective view of the light source according to an embodiment of the present disclosure. FIG. 6 is an exploded perspective view of the light source according to an embodiment of the present disclosure. FIG. 7 is a cross-sectional view taken along line A-A′ shown in FIG. 5.

Referring to FIGS. 4 to 7, the light source module 110 may include the light sources 111. The light sources 111 may include a light-emitting diode 210. The light source 111 may include an optical dome 220. Each of the plurality of light sources 111 may include the light-emitting diode 210 and the optical dome 220.

To improve the uniformity of the surface light emitted by the light source module 110 and to improve the contrast ratio by local dimming, the number of light sources 111 may be increased. As a result, an area that may be occupied by each of the plurality of light sources 111 may become smaller.

For example, to reduce the area occupied by each of the plurality of light sources 111, the light source 111 may omit an electrostatic discharge (ESD) protection circuit (e.g., a Zener diode) that prevents or suppresses damage to the light-emitting diode 210 caused by ESD. In other words, the light source 111 may not include a Zener diode connected in parallel with the light-emitting diode 210.

The light-emitting diode 210 may include a P-type semiconductor and an N-type semiconductor for emitting light by recombination of holes and electrons. The light-emitting diode 210 may be provided with a pair of electrodes 210a for supplying holes and electrons to the P-type semiconductor and the N-type semiconductor, respectively.

The light-emitting diode 210 may convert electrical energy into light energy. In other words, the light-emitting diode 210 may emit light having a maximum intensity at a given wavelength that is powered. For example, the light-emitting diode 210 may emit blue light having a peak value at a wavelength representative of the color blue (e.g., a wavelength between 450 nm and 495 nm).

For example, the light-emitting diode 210 may be directly attached to the printed circuit board 112 by a chip on board (COB) method. In other words, the light source 111 may include the light-emitting diode 210 in which a light-emitting diode chip or a light-emitting diode die is directly attached to the printed circuit board 112 without separate packaging.

For example, to reduce the area occupied by the light-emitting diode 210, the light-emitting diode 210 may be manufactured as a flip chip type that does not include a Zener diode. When attaching the light-emitting diode 210, which is a semiconductor element, to the printed circuit board 112, a flip chip type light-emitting diode 210 may fuse an electrode pattern of the semiconductor element directly to the printed circuit board 112 without utilizing an intermediate medium, such as a metal lead (wire) or a ball grid array (BGA).

As such, the light source 111 including the flip chip type light-emitting diode 210 may be miniaturized because the metal lead (wire) or the BGA is omitted. For miniaturization of the light source 111, the light source module 110 in which the flip chip type light-emitting diode 210 is attached to the printed circuit board 112 in a COB method may be manufactured.

The optical dome 220 may completely cover the light-emitting diode 210. The optical dome 220 may be configured to protect the light-emitting diode 210. The optical dome 220 may prevent or suppress damage to the light-emitting diode 210 by external mechanical action and/or damage to the light-emitting diode 210 by chemical action, or the like.

The optical dome 220 may be configured with a silicone or epoxy resin. The molten silicone or epoxy resin may be ejected (or applied) onto the light-emitting diode 210 via a nozzle or the like. As the silicone or epoxy resin ejected (or applied) onto the light-emitting diode 210 is cured, the optical dome 220 may be formed.

The optical dome 220 may vary in shape depending on the viscosity of liquid silicone or epoxy resin. For example, the optical dome 220 may be fabricated using a silicone having a thixotropic Index of approximately 2.7 to 3.3 (for example, 3.0). For example, a dome ratio may refer to the ratio of a height of a dome to a diameter of a lower surface of the dome (height/lower surface diameter of dome), and the optical dome 220 may have a dome ratio of approximately 2.5 to 3.1 (for example, 2.8).

The optical dome 220 may be optically transparent or translucent. Light emitted from the light-emitting diode 210 may pass through the optical dome 220 and be emitted to the outside.

In this case, the dome-shaped optical dome 220 may refract light like a lens. For example, light emitted from the light-emitting diode 210 may be dispersed by refraction by the optical dome 220. Such an optical dome 220 may have a spherical shape.

As such, the optical dome 220 may protect the light-emitting diode 210 from external mechanical, chemical, and/or electrical action, as well as disperse light emitted from the light-emitting diode 210.

The light source module 110 may include the printed circuit board 112. The printed circuit board 112 may be configured to support the light source 111. The printed circuit board 112 may be configured to hold the light source 111.

The printed circuit board 112 may be configured to supply electrical signals and/or power to the light source 111. The printed circuit board 112 may be configured to supply electrical signals and/or power to the light-emitting diode 210. The printed circuit board 112 may be electrically connected to a control assembly. The printed circuit board 112 may be electrically connected to a power assembly.

The printed circuit board 112 may include a non-conductive insulation layer 310. The printed circuit board may include a conductive conduction layer 320. The printed circuit board may include a plurality of protection layers 330 and 340. The printed circuit board may include at least two or more protection layers 330 and 340.

The insulation layer 310 may insulate between lines or patterns on the conduction layer 320. The insulation layer 310 may include a dielectric for electrical insulation. For example, the insulation layer 310 may be configured with an FR-4 core.

The insulation layer 310 may be configured to support the conduction layer 320.

The conduction layer 320 may form lines or patterns through which power and/or electrical signals pass. The conduction layer 320 may be configured with a variety of materials having electrical conductivity. For example, the conduction layer 320 may be configured with various metallic materials, such as copper (Cu) or tin (Sn) or aluminum (Al), or alloys thereof. For example, the conduction layer 320 may be electrically connected to the light source 111. For example, the conduction layer 320 may be electrically connected to the light-emitting diode 210.

The printed circuit board 112 may include a power supply line 350. The printed circuit board 112 may include a power supply pad 360. The power supply line 350 and the power supply pad 360 may be arranged to supply power to the light-emitting diode 210. The light-emitting diode 210 may emit light upon receiving power from the power supply line 350 and the power supply pad 360. For example, a pair of power supply pads 360 corresponding to each of the pair of electrodes 210a provided on the light-emitting diode 210 may be provided.

For example, the power supply lines 350 may be implemented by lines or patterns formed on the conduction layer 320.

For example, the power supply lines 350 may be electrically connected to the light-emitting diode 210 via the power supply pads 360.

For example, the power supply pads 360 may be formed by exposing the power supply lines 350 to the outside.

For example, a conductive adhesive material 360a may be applied to the power supply pad 360. The conductive adhesive material 360a may be configured to electrically contact between the power supply line 350 exposed to the outside and the electrode 210a of the light-emitting diode 210. For example, the conductive adhesive material 360a may be provided as one configuration of the power supply pad 360.

The electrode 210a of the light-emitting diode 210 may be in contact with the conductive adhesive material 360a. The light-emitting diode 210 may be electrically connected to the power supply line 350 via the conductive adhesive material 360a.

For example, the conductive adhesive material 360a may include a solder that is electrical conductivity. For example, the conductive adhesive material 360a may include electrically conductive epoxy adhesives. However, the present disclosure is not limited thereto, and the conductive adhesive material 360a may include a variety of materials for electrical connection between the light-emitting diode 210 and the power supply line 350.

The printed circuit board 112 may include a static electricity dissipation member 370. The static electricity dissipation member 370 may be configured to protect the light-emitting diode 210 from electrostatic discharge. The static electricity dissipation member 370 may absorb electrical shock caused by electrostatic discharge generated near the optical dome 220.

As described above, the optical dome 220 may protect the light-emitting diode 210 from external electrical action. Charge generated by electrostatic discharge may not pass through the optical dome 220 and may flow along an outer surface of the optical dome 220. The charge flowing along the outer surface of the optical dome 220 may reach the light-emitting diode 210 along a boundary between the optical dome 220 and the printed circuit board 112. The light-emitting diode 210 may be damaged due to electrical shock caused by charges penetrating along the boundary between the optical dome 220 and the printed circuit board 112. To prevent or suppress such flow of charges, i.e., electric current, the static electricity dissipation member 370 may be provided in the vicinity of the optical dome 220.

The static electricity dissipation member 370 may include a static electricity dissipation line 380. The static electricity dissipation member 370 may include a static electricity dissipation pad 390.

The static electricity dissipation line 380 may provide a path for current caused by electrostatic discharge in the vicinity of the optical dome 220. In other words, the static electricity dissipation line 380 may guide the charge from electrostatic discharge to flow to a ground. For example, the static electricity dissipation line 380 may be configured with the same material as the power supply line 350. For example, the static electricity dissipation line 380 may be configured with various metallic materials, such as copper (Cu) or tin (Sn) or aluminum (Al) or alloys thereof. However, the present disclosure is not limited thereto, and the static electricity dissipation line 380 may be configured with a material different from the power supply line 350.

The static electricity dissipation pad 390 may be configured to protect the light-emitting diode 210 from electrostatic discharge. The static electricity dissipation pad 390 may prevent or suppress current from flowing through the power supply line 350 due to electrostatic discharge. The static electricity dissipation pad 390 may prevent or suppress charges caused by electrostatic discharge from reaching the power supply pad 360. The static electricity dissipation pad 390 may prevent or suppress current caused by electrostatic discharge from flowing to the light-emitting diode 210 along the boundary between the optical dome 220 and the printed circuit board 112. The static electricity dissipation pad 390 may be configured to capture charges caused by electrostatic discharge. The charges captured by the static electricity dissipation pad 390 may flow to the ground. Thereby, durability of the light source module 110 against electrostatic discharge may be improved.

The static electricity dissipation pad 390 may be provided separately from the power supply pad 360 in contact with the light-emitting diode 210. The static electricity dissipation pad 390 may not be in contact with the light-emitting diode 210. The static electricity dissipation pad 390 may be disposed in the vicinity of the optical dome 220.

For example, the static electricity dissipation line 380 may be implemented by a line or pattern formed on the conduction layer 320.

For example, the static electricity dissipation pad 390 may be formed by exposing the static electricity dissipation line 380 to the outside.

For example, the shortest distance from an outline of the optical dome 220 to the static electricity dissipation pad 390 may be shorter than the shortest distance from the outline of the optical dome 220 to the power supply pad 360. For example, the shortest distance from the outline of the optical dome 220 to the static electricity dissipation pad 390 may be shorter than a radius of the optical dome 220.

For example, the static electricity dissipation pad 390 may be provided in a plurality. For example, the static electricity dissipation pads 390 may include a first static electricity dissipation pad 391 and a second static electricity dissipation pad 392.

However, the present disclosure is not limited to what is shown in the drawings. Three or more static electricity dissipation pads 390 may be provided. One static electricity dissipation pad 390 may be provided. The static electricity dissipation pad 390 may include a variety of shapes, such as a circular shape, a polygonal shape, a band shape, or the like.

For example, the optical dome 220 may be arranged between the first static electricity dissipation pad 391 and the second static electricity dissipation pad 392. For example, the first static electricity dissipation pad 391 and the second static electricity dissipation pad 392 may be disposed on either side of the optical dome 220. The plurality of static electricity dissipation pads 390 may be configured to surround the optical dome 220. However, the present disclosure is not limited thereto, and the static electricity dissipation pads 390 may be arranged as long as it may prevent or suppress current caused by electrostatic discharge from flowing to the power supply line 350 or the light-emitting diode 210.

The conduction layer 320 may be laminated to the insulation layer 310.

In the drawings, one conduction layer 320 is shown laminated on one insulation layer 310, but it embodiments are not limited thereto. For example, the insulation layer 310 and the conduction layer 320 may be arranged to be alternately layered. For example, the insulation layers 310 and/or conduction layers 320 may be provided in a plurality. For example, one insulation layer may be disposed between two conduction layers. For example, the conduction layer 320 may be provided as a first conduction layer 320, and the printed circuit board may further include a second conduction layer configured to support the insulation layer 310. However, the present disclosure is not limited to the examples described above, and the printed circuit board may be formed by various arrangement combinations of the insulation layer 310 and the conduction layer 320.

The printed circuit board may include the first protection layer 330. The first protection layer 330 may be configured to prevent or suppress damage to the printed circuit board due to external impact. The first protection layer 330 may be configured to prevent or suppress damage to the printed circuit board due to chemical action (e.g., corrosion, etc.). The first protection layer 330 may be configured to prevent or suppress damage to the printed circuit board due to optical action.

For example, the first protection layer 330 may include a photo solder resist (PSR), and the first protection layer 330 may be referred to as a first PSR layer 330. For example, the first protection layer 330 may be formed by a PSR process.

The first protection layer 330 may be provided to be laminated to the conduction layer 320. The first protection layer 330 may be provided to cover a portion of the conduction layer 320. The first protection layer 330 may be provided to leave a portion of the conduction layer 320 exposed. The first protection layer 330 may be provided to cover a portion of the power supply line 350. The first protection layer 330 may be provided to leave a portion of the power supply line 350 exposed. The first protection layer 330 may be provided to cover a portion of the static electricity dissipation line 380. The first protection layer 330 may be provided to leave a portion of the static electricity dissipation line 380 exposed.

The first protection layer 330 may include a first exposed portion 331. The first exposed portion 331 may be provided to expose a portion of the conduction layer 320 so as to connect the conduction layer 320 and the light-emitting diode 210. The conduction layer 320 and the light-emitting diode 210 may be in electrical contact via the first exposed portion 331.

The first protection layer 330 may be provided to form the power supply pad 360. For example, a portion of the power supply line 350 exposed to the outside by the first exposed portion 331 of the first protection layer 330 may form the power supply pad 360. For example, the conductive adhesive material 360a may be applied within the first exposed portion 331 of the first protection layer 330. For example, the conductive adhesive material 360a applied within the first exposed portion 331 may be formed as a portion of the power supply pad 360.

For example, the first exposed portion 331 may be formed by removing a portion of the first protection layer 330. For example, the first protection layer 330 may be formed by applying or coating PSR ink on the insulation layer 310, and the first exposed portion 331 may be formed by removing an uncured portion of the PSR ink applied or coated on the insulation layer 310.

For example, an edge 331a of the first exposed portion 331 may be provided to define a region of the power supply pad 360. For example, the edge 331a of the first exposed portion 331 may be provided to define a region where the conductive adhesive material 360a is applied.

The first exposed portion 331 may be referred to as a first window 331.

The optical dome 220 may be disposed on the first protection layer 330. The optical dome 220 may be disposed on the first protection layer 330 to cover the light-emitting diode 210. The optical dome 220 may be disposed on one surface 330a of the first protection layer 330 to cover the light-emitting diode 210 connected to the conduction layer 320 via the first exposed portion 331. The optical dome 220 may be disposed on a side facing a second protection layer 340 of the first protection layer 330.

The first protection layer 330 may include a second exposed portion 332. The second exposed portion 332 may be formed to be spaced apart from the first exposed portion 331. The second exposed portion 332 may be provided to expose a portion of the conduction layer 320. The conduction layer 320 exposed by the second exposed portion 332 may be provided to capture charges from electrostatic discharge.

The first protection layer 330 may be provided to form the static electricity dissipation pad 390. For example, a portion of the static electricity dissipation line 380 exposed to the outside by the second exposed portion 332 of the first protection layer 330 may form the static electricity dissipation pad 390. For example, the static electricity dissipation pad 390 may be provided around the optical dome 220 to protect the light-emitting diode 210 from electrostatic discharge.

For example, the first exposed portion 331 may be formed by removing a portion of the first protection layer 330. For example, the first protection layer 330 may be formed by applying or coating PSR ink on the insulation layer 310, and the second exposed portion 332 may be formed by removing an uncured portion of the PSR ink applied or coated on the insulation layer 310.

For example, an edge 332a of the second exposed portion 332 may be provided to define a region of the static electricity dissipation pad 390.

The second exposed portion 332 may be referred to as a second window 332.

The printed circuit board 112 may include the second protection layer 340. The second protection layer 340 may be provided to prevent or suppress damage to the printed circuit board 112 due to external impact. The second protection layer 340 may be provided to prevent or suppress damage to the printed circuit board 112 due to chemical action (e.g., corrosion, etc.). The second protection layer 340 may be provided to prevent or suppress damage to the printed circuit board 112 due to optical action. For example, the second protection layer 340 may be disposed on an outermost side of the printed circuit board 112. For example, as the second protection layer 340 is laminated to the first protection layer 330, the reflectivity of the printed circuit board 112 may be increased, thereby allowing for the omission of a reflective sheet.

For example, the second protection layer 340 may include a PSR, and the second protection layer 340 may be referred to as a second PSR layer 340. For example, the second protection layer 340 may be formed by a PSR process. For example, the second protection layer 340 may be formed by locally printing PSR ink on the first protection layer 330.

The second protection layer 340 may be provided to be laminated on the first protection layer 330. The second protection layer 340 may be provided to cover a portion of the first protection layer 330. The second protection layer 340 may be provided to expose a portion of the first protection layer 330. The second protection layer 340 may be provided to cover the static electricity dissipation pad 390. The second protection layer 340 may be provided to expose the power supply pad 360.

For example, a region where the second protection layer 340 covers the first protection layer 330 may be different from a region where the first protection layer 330 covers the conduction layer 320. For example, a region where the second protection layer 340 exposes the first protection layer 330 may be different from a region where the first protection layer 330 exposes the conduction layer 320.

The second protection layer 340 may include a third exposed portion 341.

The third exposed portion 341 may be provided to expose a portion of the first protection layer 330. The third exposed portion 341 may be provided to form a region for the optical dome 220 to be disposed on the first protection layer 330.

The third exposed portion 341 may be provided corresponding to the first exposed portion 331. The third exposed portion 341 may be provided to expose the first exposed portion 331. The third exposed portion 341 may be provided to expose the first exposed portion 331 to a side facing the light source 111 of the printed circuit board 112.

The third exposed portion 341 may be provided corresponding to the power supply pad 360. The third exposed portion 341 may be provided to expose the power supply pad 360. The third exposed portion 341 may be provided to expose the power supply pad 360 to a side facing the light source 111 of the printed circuit board 112.

For example, the light-emitting diode 210 connected to the conduction layer 320 through the first exposed portion 331 may be provided to be exposed to an outside through the third exposed portion 341. The optical dome 210 may be disposed on the first protection layer 330 to cover the light-emitting diode 210 exposed through the third exposed portion 341. Accordingly, the third exposed portion 341 may form a region for the optical dome 220 to be disposed on the first protection layer 330.

For example, the third exposed portion 341 may be provided not to correspond to the static electricity dissipation pad 390. Thus, the static electricity dissipation pad 390 may not be exposed by the third exposed portion 341. The second protection layer 340 may be provided to cover the static electricity dissipation pad 390.

For example, the third exposed portion 341 may be formed by removing a portion of the second protection layer 340. For example, the second protection layer 340 may be formed by applying or coating PSR ink on the first protection layer 330, and the third exposed portion 341 may be formed by removing an uncured portion of the PSR ink applied or coated on the first protection layer 330.

For example, an edge 341a of the third exposed portion 341 may be provided to define a region for the optical dome 220 to be disposed on the first protection layer 330.

For example, the edge 341a of the third exposed portion 341 may be spaced apart from the optical dome 220. For example, the edge 341a of the third exposed portion 341 may be provided to surround the optical dome 220.

For example, the edge 341a of the third exposed portion 341 may be provided to form a step with one surface 330a of the first protection layer 330. For example, a height of the edge 341a of the third exposed portion 341 may be approximately equal to a thickness of the second protection layer 340.

For example, the optical dome 220 may be provided to be located within a region formed by the third exposed portion 341. For example, a size of the third exposed portion 341 may be provided to be larger than that of the optical dome 220. For example, the third exposed portion 341 may include a circular shape, and a diameter of the third exposed portion 341 may be provided to be larger than a maximum diameter of the optical dome 220.

For example, a center of the third exposed portion 341 may be provided to approximately coincide with a center of the optical dome 220.

For example, the first exposed portion 331 may be provided to be located within a region formed by the third exposed portion 341. For example, the light-emitting diode 210 connected to the conduction layer 320 through the first exposed portion 331 may be provided to be located within a region formed by the third exposed portion 341.

The third exposed portion 341 may be referred to as a third window 341.

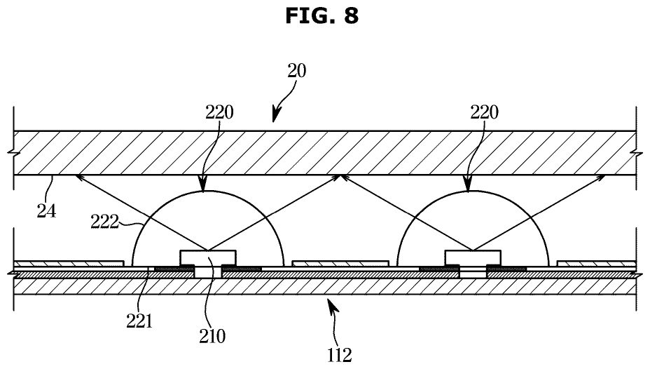

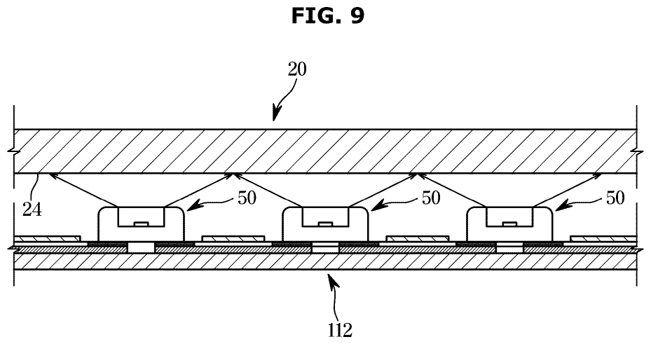

FIG. 8 is a view schematically illustrating a light emission angle (or light viewing angle) of the light source module according to an embodiment of the present disclosure. FIG. 9 is a schematic view illustrating a light emission angle of a related art LED package.

As the plurality of light sources 111 according to an embodiment of the present disclosure each includes the light-emitting diode 210 directly mounted on the printed circuit board 112 and the spherical optical dome 220 completely covering the light-emitting diode 210, light emitted from the light-emitting diode 210 may be refracted by the optical dome 220 and dispersed and diffused to the sides of the optical dome 220, thereby spreading the light emission angle. This may improve hot spots even if the number of light-emitting diodes 210 mounted on the printed circuit board 112 is reduced. In other words, fewer light-emitting diodes may be used compared to the related art LED package 50 shown in FIG. 9, which may improve the stability of the light guide plate 20 by reducing heat generating elements.

The optical dome 220 disclosed herein may include a first surface 221 in contact with a surface of the printed circuit board 112, and a second surface 222 positioned opposite the first surface 221. The first surface 221 may form an underside of the optical dome 220 in contact with the surface of the printed circuit board 112. The first surface 221 may form an area larger than an area of the light-emitting diode 210. The second surface 222 may form a light emission surface. The second surface 222 may have a spherical shape protruding convexly toward the light guide plate 20. The second surface 222 may not be in contact with one thickness surface 24 of the light guide plate 20.

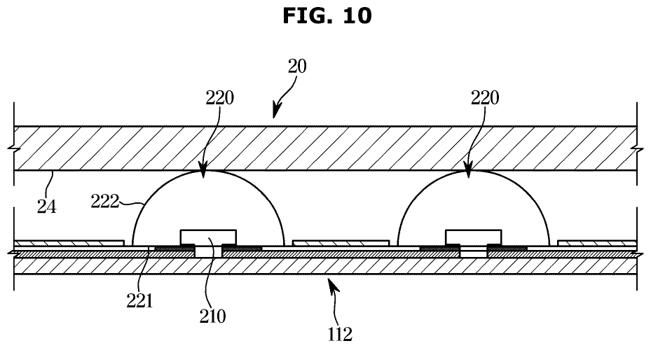

FIG. 10 is a schematic view illustrating the optical dome and the light guide plate according to an embodiment of the present disclosure.

Referring to FIG. 10, the second surface 222 of the optical dome 220 may be in a state of being in contact with one thickness surface 24 of the light guide plate 20. As the optical dome 220 contacts the light guide plate 20, the gap between the light guide plate 20 and the light source 111 may remain constant. This may have the advantage of eliminating the need for a separate gap-maintaining member to maintain the gap between the light source 111 and the light guide plate 20.

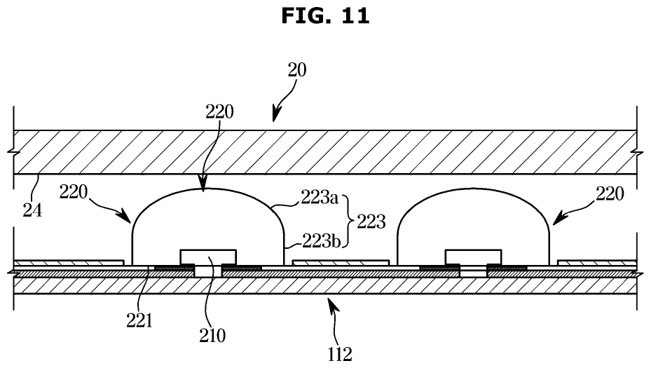

FIG. 11 is a view illustrating the optical dome according to an embodiment of the present disclosure.

Referring to FIG. 11, a second surface 223 of the optical dome 220 disclosed herein may have an aspherical shape. The second surface 223 may include a first curved portion 223a positioned on an upper portion of the light-emitting diode 210 and having a given curvature, and a first straight portion 223b positioned on a side of the light-emitting diode 210 so as to form a straight section at an end of the first curved portion 223a. The first straight portion 223b may extend from the end of the first curved portion 223a to the surface of the printed circuit board 112. The second surface 222 may be configured with a mixed structure of the first curved portion 223a and the first straight portion 223b. The first curved portion 223a may include an arc shape or a parabolic shape. The first straight portion 223b may include a vertical surface or an inclined surface. The second surface 223 may be spaced apart from the light guide plate 20. According to an embodiment, the second surface 223 may be in contact with the light guide plate 20.

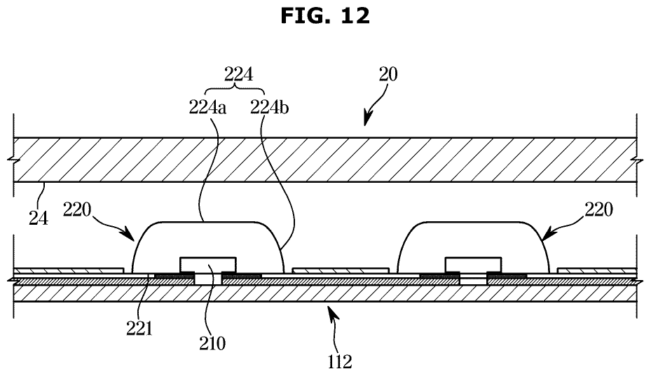

FIG. 12 is a view illustrating an optical dome according to an embodiment of the present disclosure.

Referring to FIG. 12, a second surface 224 of the optical dome 220 disclosed herein may have an aspherical shape. The second surface 222 of the optical dome 220 may include a second straight portion 224a positioned on an upper porting of the light-emitting diode 210, and a second curved portion 224b extending from an end of the second straight portion 224a to have a given curvature and positioned on a side of the light-emitting diode 210. The second straight portion 224a may extend parallel to the surface of the printed circuit board 112. The second curved portion 224b may extend from the end of the second straight portion 224a to the surface of the printed circuit board 112. The second straight portion 224a may include a horizontal surface or an inclined surface. The second curved portion 224b may include an arc shape or a parabolic shape. The second surface 224 may be spaced apart from the light guide plate 20. According to an embodiment, the second surface 224 may be in contact with the light guide plate 20.

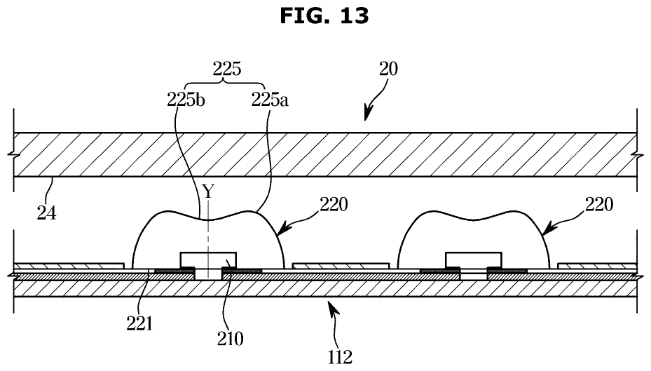

FIG. 13 is a view illustrating an optical dome according to an embodiment of the present disclosure.

Referring to FIG. 13, a second surface 225 of the optical dome 220 disclosed herein may have an aspherical shape. The second surface 225 of the optical dome 220 may include at least one convex portion 225a and at least one concave portion 225b. The at least one concave portion 225b may be positioned on a central axis Y of the optical dome 220. The at least one concave portion 225b may be formed with a concave shape in a peripheral region of the central axis Y of the optical dome 220. The at least one concave portion 225b may have a curved shape with a given curvature. The at least one convex portion 225a may be positioned on each side of the at least one concave portion 225b. The at least one convex portion 225a may have a symmetrical structure with respect to the central axis Y of the optical dome 220. The second surface 222 of such optical dome 220 may expand the emission angle of the light-emitting diode 210 having a Lambertian emission profile through total internal reflection and refraction. The second surface 225 may be spaced apart from the light guide plate 20. According to an embodiment, the second surface 225 may be in contact with the light guide plate 20.

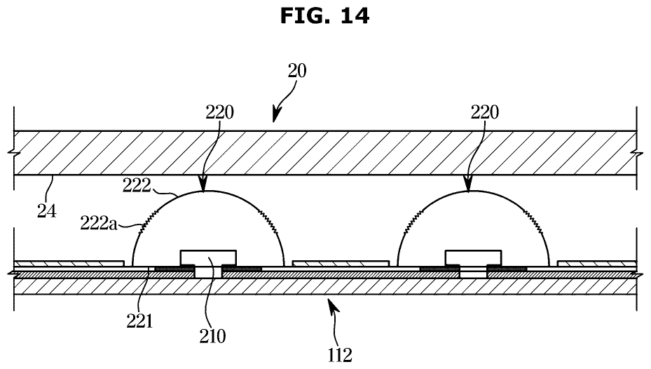

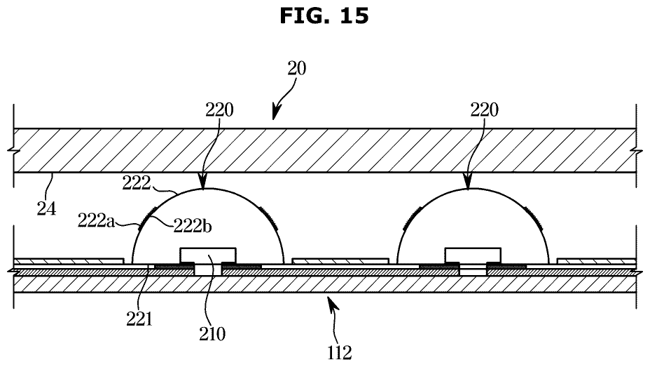

FIGS. 14 and 15 are views illustrating an optical dome according to an embodiment of the present disclosure.

Referring to FIG. 14, a plurality of protrusions 222a may be formed on the second surface 222 of the optical dome 220. The plurality of protrusions 222a may be positioned on a side of the optical dome 220 to expand a light emission angle of the light-emitting diode 210. The plurality of protrusions 222a may be formed on the surface of the optical dome 220 by molding using a mold (e.g., injection molding, transfer molding, compression molding, etc.) or by a thermal nanoimprint lithography process during the molding of the optical dome 220. Alternatively, as shown in FIG. 15, the plurality of protrusions may be formed by attaching a light-transmitting sheet 222b, on which the plurality of protrusions 222a are provided, to the surface of the optical dome 220. Such plurality of protrusions 222a may include micro protrusions of 1 μm or less. The plurality of protrusions 222a may include a sawtooth shape, a wave shape, a square shape, or the like. According to an embodiment, the optical dome 220 formed with the plurality of protrusions 222a may include an aspherical shape 223, 224, or 225.

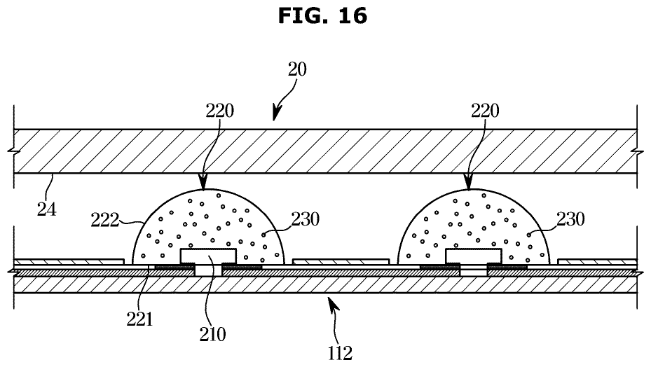

FIG. 16 is a view illustrating an optical dome according to an embodiment of the present disclosure.

Referring to FIG. 16, the optical dome 220 may include a diffusing agent 230 that diffuses light from the light-emitting diode 210. The diffusing agent 230 may include inorganic particles or organic particles. The diffusing agent 230 may widen an emission angle by diffusing light in the optical dome 220 made of a silicone material. The diffusing agent 230 may include epoxy or TiO2 present in spherical form.

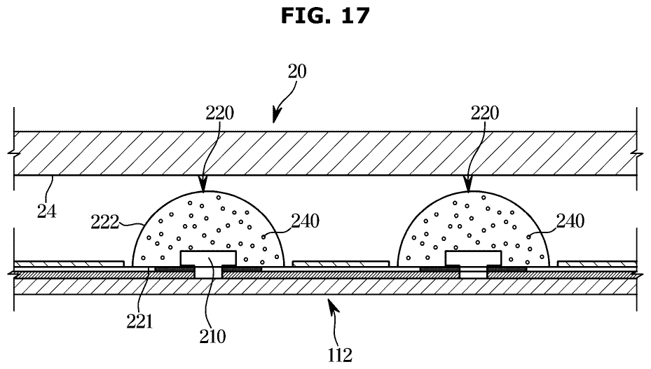

FIG. 17 is a view illustrating an optical dome according to an embodiment of the present disclosure.

Referring to FIG. 17, the optical dome 220 may include a phosphor 240 which is a wavelength converting material. The phosphor 240 may be excited by light generated by the light-emitting diode 210 to emit light of a different wavelength. When the phosphor 240 is included in the optical dome 220, the optical sheet 15 comprising a quantum dot material may be omitted. In this case, the phosphor 240 may include a quantum dot material.

Although the optical dome 220 shown in FIGS. 16 and 17 is described as having a spherical shape as an example, the optical dome 220 including at least one of the diffusing agent 230 and the phosphor 240 may have an aspherical shape.

While certain embodiments of the present disclosure have been particularly described, it should be understood by those of skilled in the art that various changes in form and dewtails may be made without departing from the spirit and scope of the present disclosure.

What is claimed is:

1. A display apparatus comprising:
a liquid crystal panel configured to display an image in a first direction at a first side of liquid crystal panel;
a light guide plate on a second side of the liquid crystal panel opposite to the first side of the liquid crystal panel;
a light source module facing a thickness side surface of the light guide plate to and configured emit light toward the thickness side surface of the light guide plate, the light source module comprising a plurality of light sources arranged along a second direction orthogonal to the first direction,
wherein each light source of the plurality of light sources comprises:
a light-emitting diode attached to a printed circuit board, and
an optical dome completely covering the light-emitting diode.

2. The display apparatus of claim 1, wherein the light-emitting diode is attached to the printed circuit board by a chip on board process.

3. The display apparatus of claim 1, wherein the optical dome comprises:
a first surface in contact with a surface of the printed circuit board; and
a second surface opposite to the first surface and forming a light emission surface.

4. The display apparatus of claim 3, wherein the second surface has a spherical shape.

5. The display apparatus of claim 3, wherein the second surface has an aspherical shape.

6. The display apparatus of claim 3, wherein the second surface comprises a curved portion and a straight portion.

7. The display apparatus of claim 6, wherein the curved portion is on an upper portion of the light-emitting diode, and the straight portion is on a side of the light-emitting diode.

8. The display apparatus of claim 6, wherein the straight portion is on an upper portion of the light-emitting diode, and the curved portion is on a side of the light-emitting diode.

9. The display apparatus of claim 3, wherein the second surface comprises at least one convex portion and at least one concave portion.

10. The display apparatus of claim 9, wherein the at least one concave portion is provided around a central axis of the optical dome.

11. The display apparatus of claim 9, wherein the at least one convex portion has a symmetrical structure with respect to a central axis of the optical dome.

12. The display apparatus of claim 3, wherein the second surface comprises a plurality of protrusions.

13. The display apparatus of claim 3, wherein the second surface comprises a light-transmitting sheet on which a plurality of protrusions are provided.

14. The display apparatus of claim 12, wherein the plurality of protrusions is on a side of the optical dome.

15. The display apparatus of claim 1, wherein the optical dome comprises silicone.
